(19) United States
(12) Patent Application Publication
(10) Pub. No.: US 2017/0322657 A1
(43) Pub. Date: Nov. 9, 2017

(54) TOUCH DISPLAY

(71) Applicant: HIMAX TECHNOLOGIES LIMITED, Tainan City (TW)

(72) Inventors: Hui-Min WANG, Tainan City (TW); Yaw-Guang CHANG, Tainan City (TW)

(21) Appl. No.: 15/146,906

(22) Filed: May 5, 2016

(51) Int. Cl. G06F 3/041

(52) U.S. Cl. CPC G06F 3/0414

(57) ABSTRACT

The present disclosure provides a touch display having a force touch function. The touch display includes a backlight module, a liquid display panel and a force touch sensing circuit. The backlight module is configured to output light and includes a metal layer and a sensing layer. The liquid display panel includes a plurality of data lines and a plurality of gate lines. The force touch sensing circuit is electrically connected to a plurality of first sensing lines to sense a force of the touch of the user through the sensing layer, in which the first sensing lines are the data lines or the gate lines. In some cases, the sensing layer can be omitted, and the metal layer is used to replace the sensing layer.

### BACKGROUND

### Field of the Invention

The present invention relates to a touch display, and more particularly to a touch display having a force touch function.

### Description of Related Art

With progress in the flat panel display (FPD) industry, there has been a tendency for consumers to shift from conventional cathode-ray tube (CRT) displays to liquid crystal displays (LCD) because LCDs have smaller volumes, lighter weights, lower radiation and lower power consumption. Nowadays, LCD panels are commercially used in consumer products, such as personal digital assistants (PDA), mobile phones, cameras, laptops and televisions.

To enable the input of the LCD to be more convenient, a touch panel is generally used in the LCD to replace traditional input devices, for example, a keyboards or a mouse. In recent year, force touch technology is applied to the touch panel, thereby enabling the touch panel to detect a force of a touch of a user.

### SUMMARY

The objective of the present invention is to provide a touch display having a force touch function.

In accordance with an embodiment of the present invention, the touch display includes a backlight module, a liquid display panel and a force touch sensing circuit. The backlight module is configured to output light and includes a metal layer and a sensing layer. The metal layer is configured to provide a shielding function. The sensing layer is disposed on the metal layer, in which the sensing layer is configured to sense a touch of a user. The liquid display panel is disposed on the backlight module to receive the light of the backlight module. The liquid display panel includes a plurality of data lines and a plurality of gate lines. The data lines are configured to provide pixel data signals. The gate lines are configured to provide scan signals. The force touch sensing circuit is electrically connected to a plurality of first sensing lines to sense a force of the touch of the user through the sensing layer, in which the first sensing lines are the data lines or the gate lines.

In another embodiment of the present invention, the touch display includes a backlight module, a liquid display panel and a force touch sensing circuit. The backlight module is configured to output light and includes a metal layer configured to provide a shielding function. The liquid display panel is disposed on the backlight module to receive the light of the backlight module. The liquid display panel includes a plurality of data lines and a plurality of gate lines. The data lines are configured to provide pixel data signals. The gate lines are configured to provide scan signals. The force touch sensing circuit is electrically connected to the data lines and the gate lines to sense a force of the touch of the user.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings.

FIG. 1a is a cross-sectional view of a structure of a touch display in accordance with an embodiment of the present invention.

FIG. 1b is a schematic diagram showing a time sequence of operation of a touch display in accordance with an embodiment of the present invention.

FIG. 1c is a top view of a sensing layer of a touch display in accordance with an embodiment of the present invention.

FIG. 2 is a cross-sectional view of a structure of a touch display in accordance with an embodiment of the present invention.

FIG. 3a is a cross-sectional view of a structure of a touch display in accordance with an embodiment of the present invention.

FIG. 3b is a top view of a sensing layer of a touch display in accordance with an embodiment of the present invention.

FIG. 4 is a cross-sectional view of a structure of a touch display in accordance with an embodiment of the present invention.

FIG. 5 is a cross-sectional view of a structure of a touch display in accordance with an embodiment of the present invention.

FIG. 6 is a cross-sectional view of a structure of a touch display in accordance with an embodiment of the present invention.

### DETAILED DESCRIPTION

The detailed explanation of the present invention is described as following. The described preferred embodiments are presented for purposes of illustrations and description, and they are not intended to limit the scope of the present invention.

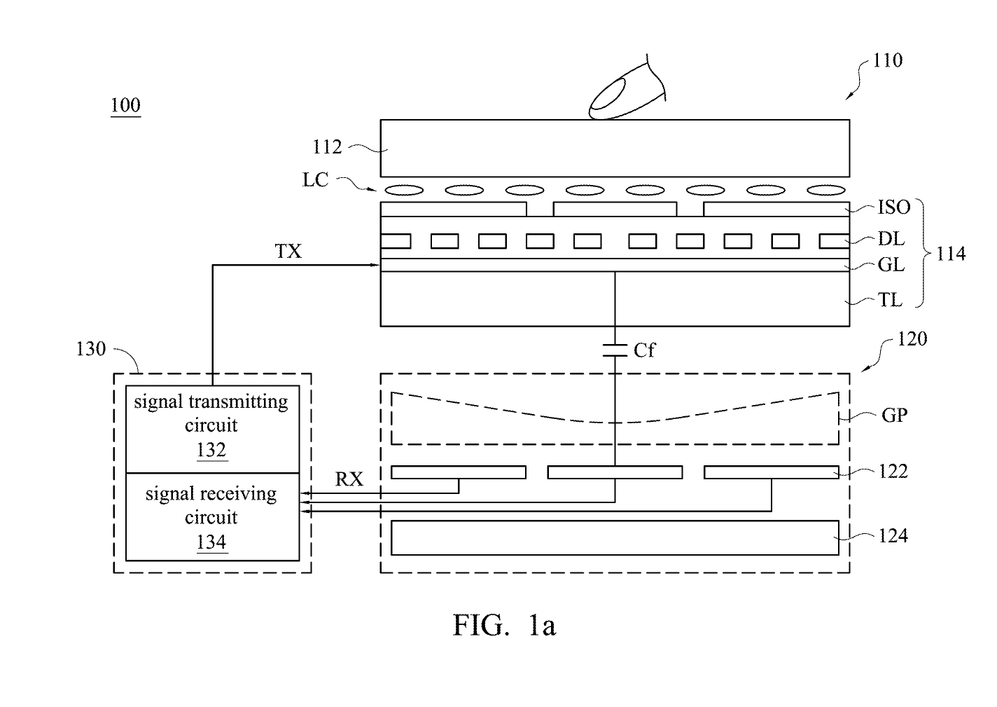

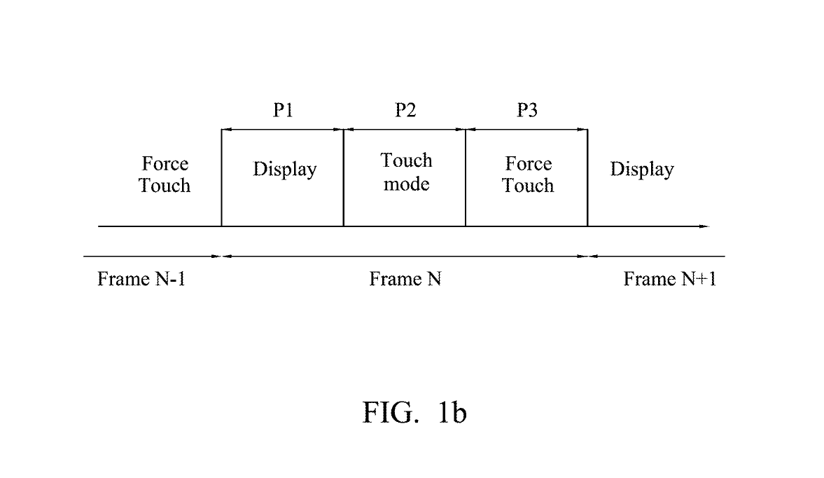

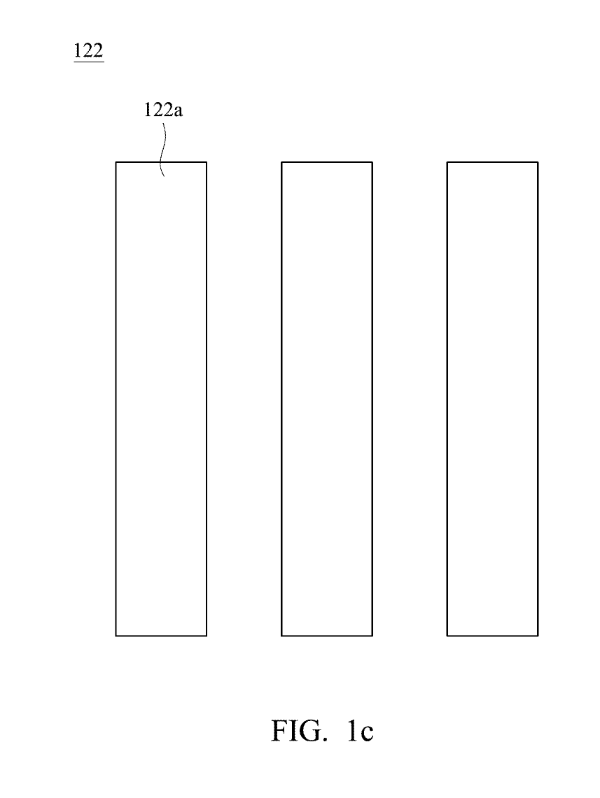

Referring to FIG. 1a and FIG. 1b, FIG. 1a is a cross-sectional view of a structure of a touch display 100 in accordance with an embodiment of the present invention, and FIG. 1b is a schematic diagram showing a time sequence of operation of the touch display 100. The operation of the touch display 100 includes a display period P1, a touch mode period P2 and a force touch period P3. The display period P1 is used to display images, the touch mode period P2 is used to sense a touch trace of a user, and the force touch period P3 is used to sense the force of the touch of the user. In this embodiment, in a frame N, the display period P1 is performed at first, and then the touch mode period P2 and the force touch period P3 are performed sequentially. However, embodiments of the present invention are not limited thereto.

The touch display 100 includes a liquid display panel 110, a backlight module 120 and a force touch sensing circuit 130. The liquid display panel 110 includes an upper portion 112, a liquid crystal layer LC and a lower portion 114. In this embodiment, the upper portion 112 includes a color filter substrate, a cover lens disposed on the color filter substrate, and a touch sensing circuit used for sensing the touch of the user. However, embodiments of the present invention are not limited thereto. The lower portion 114 includes a conductor layer ISO for providing a ground shielding function, a plurality of data lines DL and gate lines GL, and a thin-film-transistor (TFT) circuit layer TL. In this embodiment, the lower portion 114 is a TFT array substrate, but embodiments of the present invention are not limited thereto.

The backlight module 120 includes a gap portion GP, a sensing layer 122 and a metal layer 124. The gap portion GP is located on the sensing layer 122 and configure to be deformed when the user touches the touch display 100. The sensing layer 122 is located between the gap portion GP and the metal layer 124 to sense the touch of the user. The metal layer 124 is configured to provide a shielding function for the display 100.

The force touch sensing circuit 130 includes a signal transmitting circuit 132 and a signal receiving circuit 134. The signal transmitting circuit 132 is electrically connected to first sensing lines to transmit a sensing signal TX, such as a square wave signal or a triangle wave signal, to the first sensing lines. In this embodiment, the first sensing lines are the gate lines GL, but embodiments of the present invention are not limited thereto. In another embodiment of the present invention, the first sensing lines are the data lines DL. In other words, the signal transmitting circuit 132 transmits a sensing signal TX to the data lines DL in the embodiment.

The signal receiving circuit 134 is electrically connected to the sensing layer 122 to receive a response signal RX from the sensing layer 122. The response signal is generated on the sensing layer 122 in accordance with the sensing signal TX and the touch of the user. For example, when the user touches the touch display 100, the gap portion GP is deformed (for example, a surface of the gap portion GP is recessed), thereby varying a capacitance of an equivalent capacitor Cf formed between the gate lines GL and the sensing layer 122. At this moment, the response signal RX is generated on the sensing layer 122 due to the variation of the capacitance of the equivalent capacitor Cf, and the signal receiving circuit 134 receives the response signal RX to determine the force of the touch of the user.

Referring to FIG. 1c, FIG. 1c is a top view of the sensing layer 122. In this embodiment, the sensing layer 122 includes a plurality of second sensing lines 122a, and each of the second sensing lines 122a is electrically connected to the force touch sensing circuit 130. The second sensing lines 122a are arranged to enable projections of the second sensing lines 122a and the gate lines GL are perpendicular to each other, when the second sensing lines 122a and the gate lines GL are projected on the same surface. Therefore, the force touch sensing circuit 130 can obtain the position touched by the user through the sensing layer 122 and the gate lines GL.

In the embodiment that the signal transmitting circuit 132 transmits the sensing signal TX to the data lines DL, the second sensing lines 122a are arranged to enable projections of the second sensing lines 122a and the data lines DL are perpendicular to each other, when the second sensing lines 122a and the data lines DL are projected on the same surface.

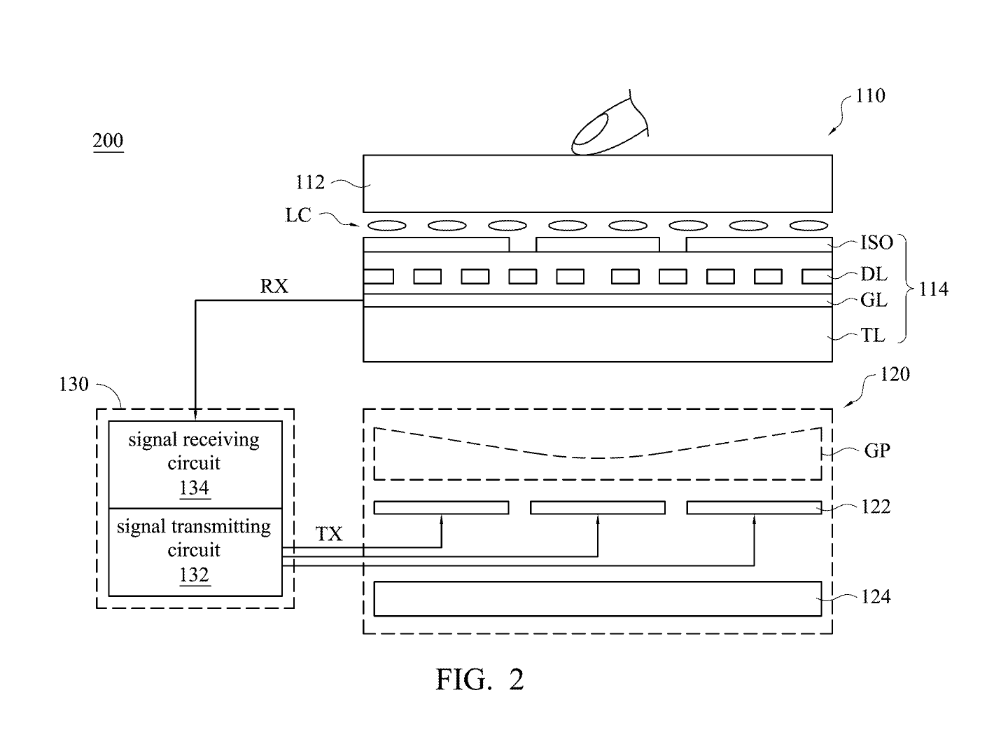

Referring to FIG. 2, FIG. 2 is a cross-sectional view of a structure of a touch display 200 in accordance with an embodiment of the present invention. The touch display 200 is similar to the touch display 100, but the difference is in that the signal transmitting circuit 132 transmits the sensing signal TX to the sensing layer 122, and the signal receiving circuit 134 receives the response signal RX from the gate lines GL. In another embodiment, the signal receiving circuit 134 receives the response signal RX from the data lines DL, when the signal transmitting circuit 132 transmits the sensing signal TX to the sensing layer 122.

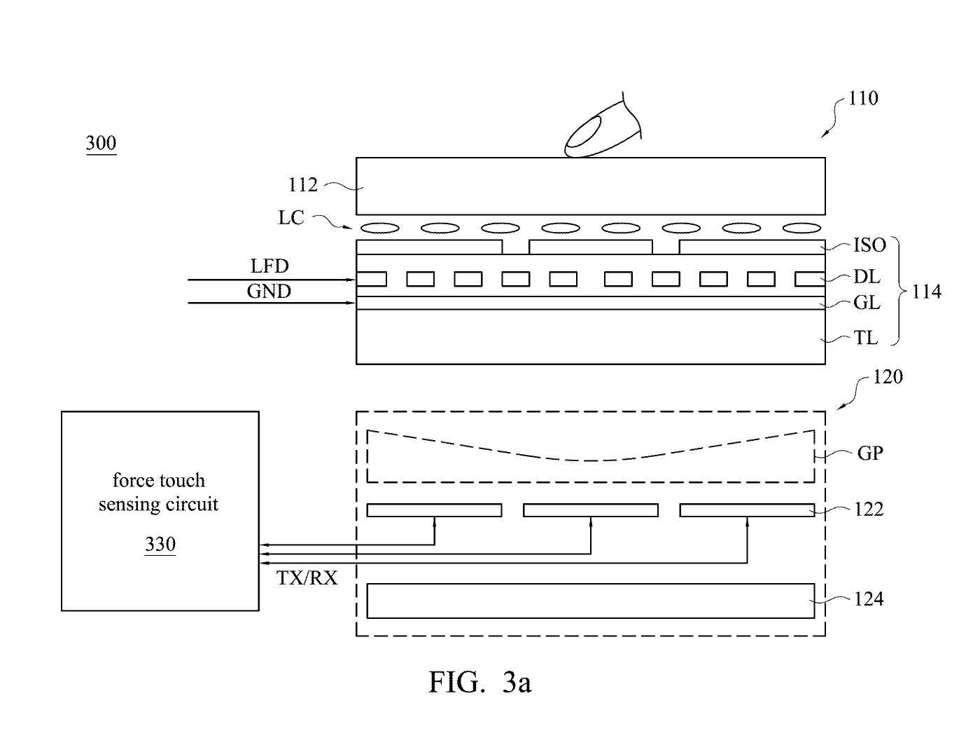

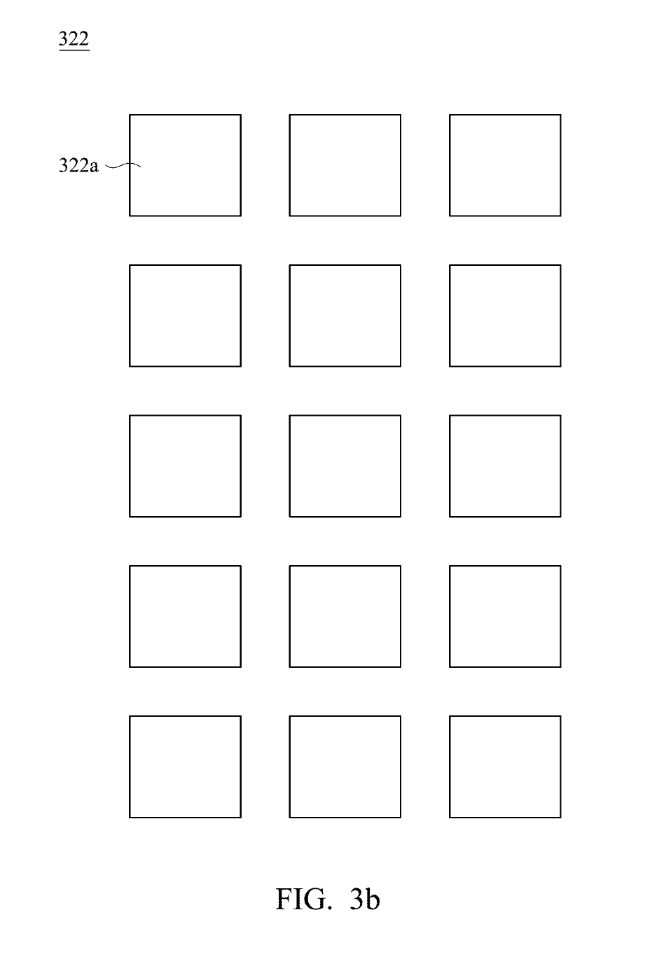

Referring to FIG. 3a, FIG. 3a is a cross-sectional view of a structure of a touch display 300 in accordance with an embodiment of the present invention. The touch display 300 is similar to the touch display 100, but the difference is in that the touch display 300 operates in a self-mode.

The touch display 300 includes a force touch sensing circuit 330 electrically connected to the sensing layer 122, and a ground reference signal GND is applied to the gate lines GL. The force touch sensing circuit 330 is configured to transmit the sensing signal TX to the sensing layer 122 and receive the response signal RX from the sensing layer 122. For example, when the user touches the touch display 300, a capacitance of an equivalent capacitor between the gate lines GL and the sensing layer 122 is varied, and the signal on the sensing layer 122 is varied. Then, the force touch sensing circuit 330 can detect the variance of the signal on the sensing layer 122 (the response signal RX) to determine the force of the touch of the user.

In this embodiment, a synchronization signal LFD is applied to the data lines DL to omit the influence of an equivalent capacitor between data lines DL and the sensing layer 122, in which the synchronization signal LFD is synchronized with the sensing signal TX applied to the sensing layer 122. However, in another embodiment of the present invention, the ground reference signal GND is applied to the data lines DL and the synchronization signal LFD is applied to the gate lines GL. In this case, the response signal RX is generated in accordance with a variance of a capacitance of an equivalent capacitor between the data lines DL and the sensing layer 122, and the influence of the equivalent capacitor between the gate lines GL and the sensing layer 122 is omitted.

Referring to FIG. 3b, FIG. 3b is a top view of a sensing layer 322 in accordance with embodiments of the present invention. The sensing layer 322 can be used to replace the sensing layer 122 of the touch display 300. In this embodiment, the sensing layer 322 includes a plurality of sensing blocks 322a arranged in a matrix, and each of the sensing blocks 322a is electrically connected to the force touch sensing circuit 330. Therefore, the force touch sensing circuit 330 can obtain the position touched by the user through the sensing layer 322.

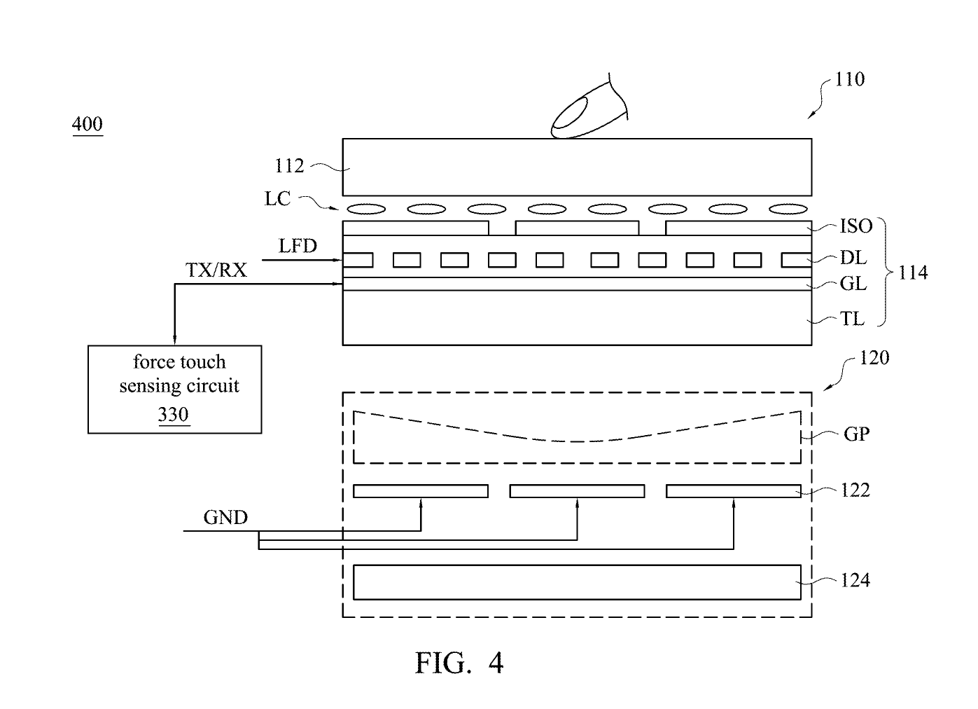

Referring to FIG. 4, FIG. 4 is a cross-sectional view of a structure of a touch display 400 in accordance with an embodiment of the present invention. The touch display 400 is similar to the touch display 300, but the difference is in that the force touch sensing circuit 330 is electrically connected to the gate lines GL, and the ground reference signal GND is applied to the sensing layer 122. Therefore, when the user touches the touch display 300, a capacitance of an equivalent capacitor between the gate lines GL and the sensing layer 122 is varied, and the signal on the gate lines GL is varied accordingly. Then, the force touch sensing circuit 330 can detect the variance of the signal on the gate lines GL (the response signal RX) to determine the force of the touch of the user.

In another embodiment of the present invention, the ground reference signal GND is applied to the data lines DL, and the synchronization signal LFD is applied to the sensing layer 122. Therefore, when the user touches the touch display 300, a capacitance of an equivalent capacitor between the gate lines GL and the data lines is varied, and the signal on the gate lines GL is varied accordingly. Then, the force touch sensing circuit 330 can detect the variance of the signal on the gate lines GL to determine the force of the touch of the user.

In further another embodiment of the present invention, the force touch sensing circuit 330 can be electrically connected to the data lines DL. In this case, the ground reference signal GND is applied to the data lines DL or the sensing layer 122, and the synchronization signal LFD is applied to the other.

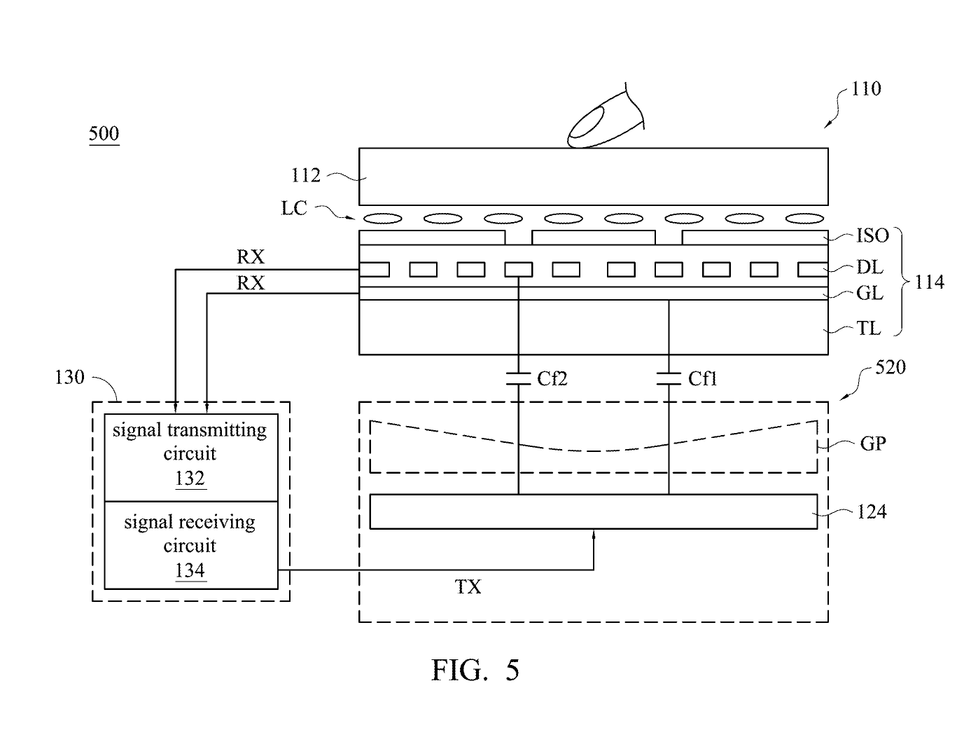

Referring to FIG. 5, FIG. 5 is a cross-sectional view of a structure of a touch display 500 in accordance with an embodiment of the present invention. The touch display 500 is similar to the touch display 100, but the difference is in that the touch display 500 does not include the sensing layer 122.

In this embodiment, since the touch display 500 does not include the sensing layer 122, the signal transmitting circuit is electrically connected to the metal layer 124 to transmit the sensing signal TX to the metal layer 124. Further, the signal receiving circuit 134 is electrically connected to the gate lines GL and data lines DL to receive the response signals RX from the gate lines GL and data lines DL. For example, when the user touches the touch display 500, a capacitance of an equivalent capacitor Cf1 between the gate lines GL and the metal layer 124 is varied, and a capacitance of an equivalent capacitor Cf2 between the data lines DL and the metal layer 124 is varied too. The variance of the capacitance of the equivalent capacitors Cf1 and Cf2 results in variance of the signal on the gate lines GL and the data lines DL. Thus, the force touch sensing circuit 130 can detect the variance of the signal on the gate lines GL and the data lines DL (the response signal RX) to determine the force of the touch of the user.

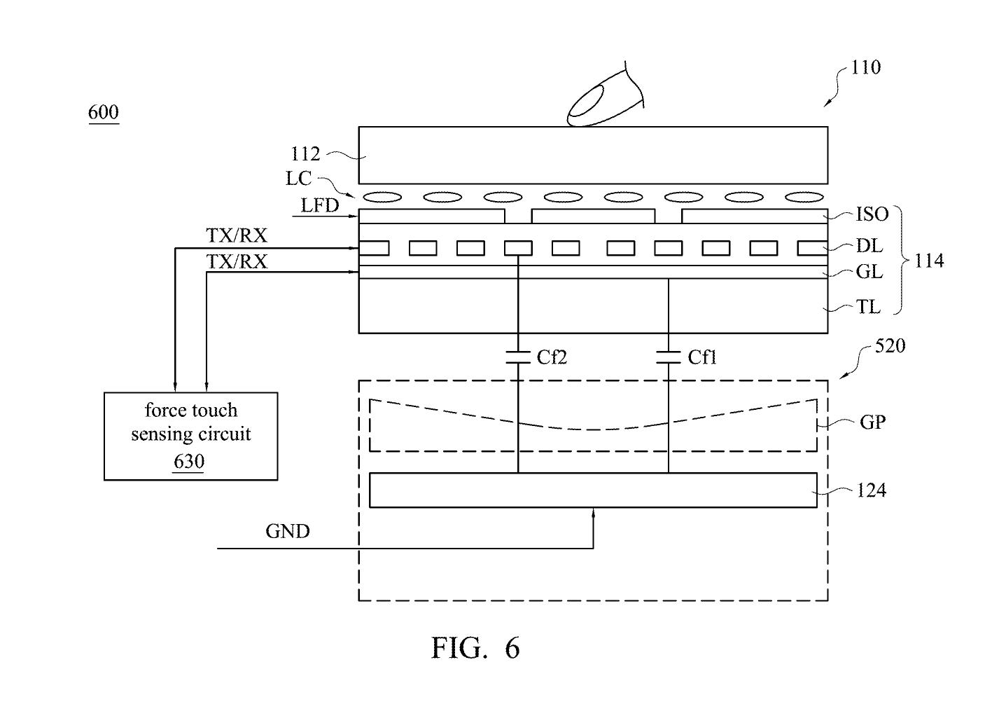

Referring to FIG. 6, FIG. 6 is a cross-sectional view of a structure of a touch display 600 in accordance with an embodiment of the present invention. The touch display 600 is similar to the touch display 500, but the difference is in that the touch display 600 operates in a self-mode.

The touch display 600 includes a force touch sensing circuit 630 electrically connected to the gate lines GL and the data lines DL, and a ground reference signal GND is applied to the metal layer 124. The force touch sensing circuit 630 is configured to transmit the sensing signal TX to the gate lines GL and the data lines DL and receive the response signal RX from the gate lines GL and the data lines DL. For example, when the user touches the touch display 600, the capacitance of the equivalent capacitors Cf1 and Cf2 is varied, and the signal on the gate lines GL and the data lines DL is varied accordingly. Thus, the force touch sensing circuit 630 can detect the variance of the signal on the gate lines GL and the data lines DL (the response signal RX) to determine the force of the touch of the user. In this embodiment, the synchronization signal LFD is applied to the conductor layer ISO.

In another embodiment of the present invention, the synchronization signal LFD is applied to the metal layer 124, and the ground reference signal GND is applied to the conductor layer ISO. In this case, when the user touches the touch display 600, a capacitance of an equivalent capacitor between the gate lines GL and the conductor layer ISO is varied, and a capacitance of an equivalent capacitor between the data lines DL and the conductor layer ISO is varied too. The variance of the capacitance results in variance of the signal on the gate lines GL and the data lines DL. Thus, the force touch sensing circuit 630 can detect the variance of the signal on the gate lines GL and the data lines DL (the response signal RX) to determine the force of the touch of the user.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims.

What is claimed is:

1. A touch display, comprising:
a backlight module configured to output light, wherein the backlight module comprises:
a metal layer configured to provide a shielding function; and
a sensing layer disposed on the metal layer, wherein the sensing layer is configured to sense a touch of a user;
a liquid display panel disposed on the backlight module to receive the light of the backlight module, comprising:
a plurality of data lines configured to provide pixel data signals; and
a plurality of gate lines configured to provide scan signals; and
a force touch sensing circuit electrically connected to a plurality of first sensing lines to sense a force of the touch of the user through the sensing layer, wherein the first sensing lines are the data lines or the gate lines.

2. The touch display of claim 1, wherein the sensing layer consists of a plurality of second sensing lines perpendicular to first sensing lines.

3. The touch display of claim 2, wherein the force touch sensing circuit comprises:
a signal transmitting circuit electrically connected to the first sensing lines, wherein the signal transmitting circuit is configured to transmit a sensing signal to the first sensing lines; and
a signal receiving circuit electrically connected to the second sensing lines, wherein the signal receiving circuit is configured to receive a response signal from the second sensing lines, and the response signal is generated on the second sensing lines in accordance with the sensing signal and the touch of the user.

4. The touch display of claim 2, wherein the force touch sensing circuit comprises:
a signal transmitting circuit electrically connected to the second sensing lines, wherein the signal transmitting circuit is configured to transmit a sensing signal to the second sensing lines; and
a signal receiving circuit electrically connected to the first sensing lines, wherein the signal receiving circuit is configured to receive a response signal from the first sensing lines, and the response signal is generated on the first sensing lines in accordance with the sensing signal and the touch of the user.

5. The touch display of claim 1, wherein the force touch sensing circuit is electrically connected to the first sensing lines to transmit a sensing signal to the first sensing lines and receive a response signal from the first sensing lines, and the response signal is generated on the first sensing lines in accordance with the sensing signal and the touch of the user.

6. The touch display of claim 5, wherein a ground reference signal is applied to the sensing layer, and a synchronization signal, synchronized with the sensing signal, is applied to the data lines when the first sensing lines are the gate lines.

7. The touch display of claim 5, wherein a ground reference signal is applied to the data lines, and a synchronization signal, synchronized with the sensing signal, is applied to the sensing layer when the first sensing lines are the gate lines.

8. The touch display of claim 5, wherein a ground reference signal is applied to the sensing layer, and a synchronization signal, synchronized with the sensing signal, is applied to the gate lines when the first sensing lines are the data lines.

9. The touch display of claim 5, wherein a ground reference signal is applied to the gate lines, and a synchronization signal, synchronized with the sensing signal, is applied to the sensing layer when the first sensing lines are the data lines.

10. The touch display of claim 1, wherein the force touch sensing circuit is electrically connected to the sensing layer to transmit a sensing signal to the sensing layer and receive a response signal from the sensing layer, and the response signal is generated on the sensing layer in accordance with the sensing signal and the touch of the user.

11. The touch display of claim 10, wherein a ground reference signal is applied to the gate lines, and a synchronization signal, synchronized with the sensing signal, is applied to the data lines.

12. The touch display of claim 10, wherein a ground reference signal is applied to the data lines, and a synchronization signal, synchronized with the sensing signal, is applied to the gate lines.

13. A touch display, comprising:
a backlight module configured to output light, wherein the backlight module comprises a metal layer configured to provide a shielding function;
a liquid display panel disposed on the backlight module to receive the light of the backlight module, comprising:
a plurality of data lines configured to provide pixel data signals; and
a plurality of gate lines configured to provide scan signals; and
a force touch sensing circuit electrically connected to the data lines and the gate lines to sense a force of the touch of the user.

14. The touch display of claim 13, wherein the force touch sensing circuit comprises:
a signal transmitting circuit electrically connected to the metal layer, wherein the signal transmitting circuit is configured to transmit a sensing signal to the metal layer; and
a signal receiving circuit electrically connected to the data lines and the gate lines, wherein the signal receiving circuit is configured to receive response signals from the data lines and the gate lines, and the response signals are generated on the data lines and the gate lines in accordance with the sensing signal and the touch of the user.

15. The touch display of claim 13, wherein the force touch sensing circuit is electrically connected to the data lines and the gate lines to transmit a sensing signal to the data lines and the gate lines and to receive the response signals from the data lines and the gate lines, and the response signals are generated on the data lines and the gate lines in accordance with the sensing signal and the touch of the user.

16. The touch display of claim 15 wherein a synchronization signal, synchronized with the sensing signal, is applied to the metal layer, and a ground reference signal is applied to a conductor layer disposed on the data lines and the gate lines.

17. The touch display of claim 15, wherein a synchronization signal, synchronized with the sensing signal, is applied to a conductor layer disposed on the data lines and the gate lines, and a ground reference signal is applied to the metal layer.
